(19) United States
(12) Patent Application Publication
(10) Pub. No.: US 2003/0089166 A1
(43) Pub. Date: May 15, 2003

(54) Torque detection device

(76) Inventors: Yutaka Mizuno, Shizuoka (JP); Tsuyoshi Kubota, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/293,401

(22) Filed: Nov. 12, 2002

(30) Foreign Application Priority Data
Nov. 13, 2001 (JP) 2001-349089

(51) Int. Cl. G01M 19/00

(52) U.S. Cl. 73/118.1

(57) ABSTRACT

An all-terrain vehicle having at least one front wheel and a handlebar assembly. A steering column extending from the handlebar assembly to the at least one front wheel to turn the front wheel in response to rotation of the handlebar assembly. A torque detection device is configured to detect a torque applied to the steering column. The torque detection device may produce an output signal corresponding with the torque applied to the steering column to be used by a control system, for example, in controlling the output of a steering assist motor. The torque detection device includes a pressure receiving element to which a load is applied during rotation of the steering column. A sensor detects the load applied to the pressure receiving element to permit the torque applied to the steering column to be ascertained. In one arrangement, a pair of pressure receiving elements and an associated pair of sensors may be provided and the torque applied to the steering column may be ascertained from a difference between the load applied to each of the pressure receiving elements.

### RELATED APPLICATIONS

This application is related to, and claims priority from, Japanese Patent Application No. 2001-349,089, filed Nov. 13, 2001, the entirety of which is incorporated by reference herein.

### BACKGROUND OF THE INVENTION

1. Field of the Invention

The present invention generally relates to all-terrain vehicles (ATVs) featuring a power steering assist unit. More particularly, the present invention relates to a torque detection device for an ATV having a power steering assist unit.

2. Brief Description of the Related Art

Typically, ATVs feature internal combustion engines that supply power to the wheels that drive the vehicles over the ground. The engines generally are mounted at least partially below seats on which operators of the ATVs are seated during operation. Suitable transmissions, which can include shaft drives, belt drives and chain drives, supply the power from the internal combustion engines to the wheels. In some arrangements, the transmissions allow for reverse operation of the ATVs and, in some arrangements, the transmission may supply power to all of the wheels (e.g., four-wheel drive).

ATVs generally are smaller vehicles that are used for sport and work. For instance, ATVs can be operated for recreational riding in desert areas, wooded areas, and mountainous areas. Many environments where the ATVs are operated cause the steering of the vehicle to become challenging, causing operator fatigue. For instance, during low speed operation, the weight of modern ATVs makes steering more challenging. As a result, it has become increasingly popular to provide a power steering system in which a steering assist motor is provided to assist in rotating a steering column of the ATV. With such construction, the ATV can be steered with a relatively small steering input force from the operator of the ATV.

Such power steering systems are configured to detect rotational torque of the steering column and control an output of the steering assist motor in a predetermined relationship to the detected rotational torque of the steering column. In one arrangement, the steering column of the ATV is divided into upper and lower steering column portions. A torsion bar is coupled to one of the portions of the steering column and extends toward the other. The torsion bar, in cooperation with a position sensor positioned on the other of the column portions, is configured to determine an angle between the upper and lower steering column portions, which angle is caused by rotational deflection of the steering column. The angle between the upper and lower portions of the steering column is a function of the torque applied and, in some cases, the configuration of the torsion bar. The output of the steering assist motor is then controlled in a predetermined relationship to the torsional angle between the upper and lower steering column portions. However, relative rotational movement between the upper and lower portions of the steering column results in poor response of the steering system to steering inputs by an operator of the ATV. In addition, such an arrangement is complex in structure, thus adding additional weight and additional manufacturing cost to the final vehicle.

Another method for detecting rotational torque of the steering column involves positioning a magnetostrictive sensor in a non-contact, coaxial relationship about the steering column. The sensor is configured to detect a change in the value of a magnetic property of the steering column due to the rotational torque being applied thereto. An output of the power assist motor then is adjusted in accordance with a predetermined relationship to the detected rotational torque of the steering column. However, such an arrangement is sensitive to changes in temperature, variations in the size of the steering column due to normal manufacturing tolerances, and vibration while in use. Overcoming these problems results in the torque detective assembly being unduly expensive to manufacture.

### SUMMARY OF THE INVENTION

Thus, a reliable, cost-effective torque detection device is desired that is capable of determining a torque applied to the steering column of an ATV. Accordingly, preferred embodiments of the present torque detection device generally provide more accurate detection of torque applied to the steering column of an ATV with relatively small deformations of the steering column. In addition, preferred embodiments generally provide an improved operating feel to steering inputs made by an operator of the ATV. Furthermore, preferred embodiments generally are better insulated from variations due to external forces, such as vibrations or changes in temperature.

An aspect of the present invention involves an all-terrain vehicle having a frame assembly, at least one front wheel, and at least one rear wheel. A handlebar assembly is coupled to the at least one front wheel by a steering assembly, including a steering column. A torque detection device is configured to detect a torque applied to the steering column, and includes at least one pressure receiving element and at least one sensor. The steering assembly is configured to apply a load to the at least one pressure receiving element during rotation of the steering column and the at least one sensor is configured to detect the load applied to the at least one pressure receiving element.

Another aspect of the present invention involves an all-terrain vehicle comprising a frame assembly, a pair of front wheels, and at least one rear wheel. A handlebar assembly is coupled to the at least one front wheel by a steering assembly, which includes a steering column, a connector plate and a pair of tie rods. The connector plate is fixed for rotation with the steering column. Each of the pair of tie rods extend from the connector plate to one of the pair of front wheels. A torque detection device is configured to detect a torque applied to the steering column, and includes a first pressure receiving element, a second pressure receiving element, a first sensor configured to detect the load applied to the first pressure receiving element and a second sensor configured to detect the load applied to the second pressure receiving element. The steering assembly is configured to apply a compressive load to the first pressure receiving element during rotation of the steering column in a first direction and apply a compressive load to the second pressure receiving element during rotation of the steering column in a second direction.

Yet another aspect of the present invention involves a method for detecting a torque applied to a steering column of a vehicle. The method includes providing at least one pressure receiving element exhibiting a change in a physical property resulting from a change in a load applied. The method further includes applying a load to the at least one pressure receiving element during rotation of the steering column and determining a value of the physical property of the at least one pressure receiving element as a result of the load applied. Furthermore, the method includes calculating the torque applied to the steering column using the detected value of the physical property.

### BRIEF DESCRIPTION OF THE DRAWINGS

The foregoing features, aspects, and advantages of the present invention will now be described with reference to the drawings of preferred embodiments, which are intended to illustrate and not to limit the invention. The drawings comprise 17 figures.

FIG. 1 is a perspective view of an all-terrain vehicle having certain features, aspects and advantages of the present invention.

FIG. 2 is a perspective view of a front portion of a frame assembly of the all-terrain vehicle of FIG. 1, illustrating a steering system including a handlebar assembly, and a pair of connecting rods.

FIG. 3 is a side elevational view of the front portion of the frame and steering assembly shown in FIG. 2.

FIG. 4 is a schematic, top view of the steering assembly and front wheels of the all-terrain vehicle of FIG. 1.

FIG. 5 is an enlarged, front view of a steering column and a presently preferred torque detecting device.

FIG. 6 is a cross-sectional view of the torque detecting device of FIG. 5 taken along the view line 6-6 of FIG. 5.

FIG. 7 is an enlarged, front view of the steering column and a modification of the torque detection device of FIG. 5.

FIG. 8 is a cross-sectional view of the steering column and torque detection device of FIG. 7, taken along the view line 8-8 of FIG. 7.

FIG. 9 is an enlarged, front view of the steering column and yet another modification of the torque detection device of FIG. 5.

FIG. 10 is a cross-sectional view of the torque detection device of FIG. 9 taken along view line 10-10 of FIG. 9.

FIG. 11 is an enlarged, front view of a lower portion of the steering column and connecting rods of the steering assembly of FIG. 2, illustrating another presently preferred construction of a torque detection device.

FIG. 12 is an enlarged view of an upper end of the left connecting rod of FIG. 11.

FIG. 13 is a schematic, top view of yet another preferred construction of the torque detection device, incorporated within a connecting plate, or pitman arm, of the steering system of FIG. 2.

FIG. 14 is an enlarged, front view of the steering column and an additional preferred construction of the torque detection device.

FIG. 15 is a top view of the torque detection device of FIG. 14.

FIG. 16 is a partial top view of a modification of the torque detection device of FIGS. 14 and 15.

FIG. 17 is a modification of the torque detection device of FIG. 16.

### DETAILED DESCRIPTION OF THE PREFERRED EMBODIMENTS

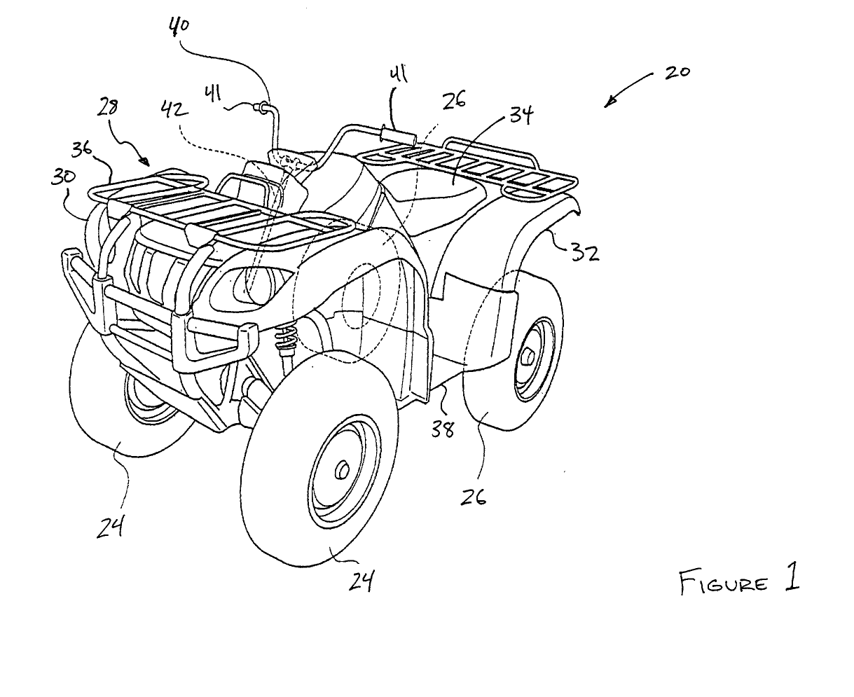

With reference initially to FIGS. 1-4, an all-terrain vehicle 20 that is arranged and configured in accordance with certain features, aspects and advantages of the present invention is illustrated therein. The vehicle 20 is in environment in which certain features, aspects and advantages of the present invention have particular utility. It should be noted that certain features, aspects and advantages of the present invention also may have utility with other types of vehicles, such as small buggies, lawnmowers, snowmobiles, small street vehicles, personal watercraft and the like.

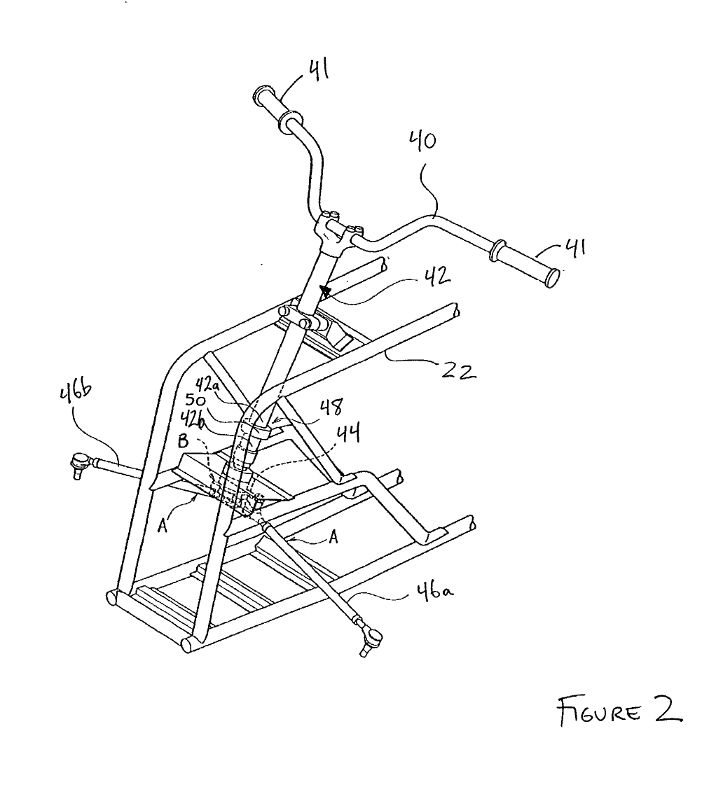

The vehicle 20 generally includes a frame assembly 22 (FIG. 2). The frame assembly 22 can have any suitable construction. In one arrangement, the frame assembly 22 is a welded-up configuration of tubing. Other frame assemblies can comprise, for instance, a centrally extending tube from which elements are cantilevered to either side as desired. Other suitable frame assemblies 22 also can be used.

In the illustrated arrangement, a pair of front wheels 24 and a pair of rear wheels 26 support the frame assembly 22. The wheels 24, 26 can be mounted to the frame assembly 22 in any suitable manner. In one arrangement, a single rear wheel can be used. In other arrangements, a single front wheel can be used. Preferably, each of the wheels 24, 26 comprises a lower pressure, balloon tire designed for off-road use.

The vehicle 20 also includes a body assembly 28. The body assembly 28 generally is comprised of a front fender assembly 30, a rear fender assembly 32 and a seat 34. In the illustrated arrangement, the frame assembly 22 supports each of these components 30, 32, 34 of the body assembly 28 in any suitable manner.

The front fender assembly 30 generally is positioned over the front wheels 24 and can be attached to the frame assembly 22 with threaded fasteners or any other suitable mechanically interlocking structure. The front fender assembly 30 can comprise a rack 36 that extends over a portion of the upper surface of the front fender 30. Other arrangements also are possible.

The rear fender assembly 32 generally is positioned behind at least a portion of the seat 34 and over the rear wheels 26. The rear fender assembly 32 can be attached to the frame assembly 22 with threaded fasteners or any other suitable mechanically interlocking structure. Preferably, a footboard 38 (only one shown) extends between a portion of the front fender assembly 30 and a portion of the rear fender assembly 32 on each side of the vehicle 20. Thus, there preferably are two footboards. The footboards 38 desirably are easily removed from the frame assembly 22.

The footboards 38 extend to either side of the seat 34 and, in some arrangements, may extend across the lateral width of the vehicle 20 such that a portion of the footboards extend along a forward end of the seat 34. In the illustrated arrangement, however, the seat 34 preferably accommodates a single rider seated in a generally straddled fashion (i.e., having one leg on each of the footboards 38) or a plurality of riders seated in a generally tandem, straddle fashion (i.e., one behind the other).

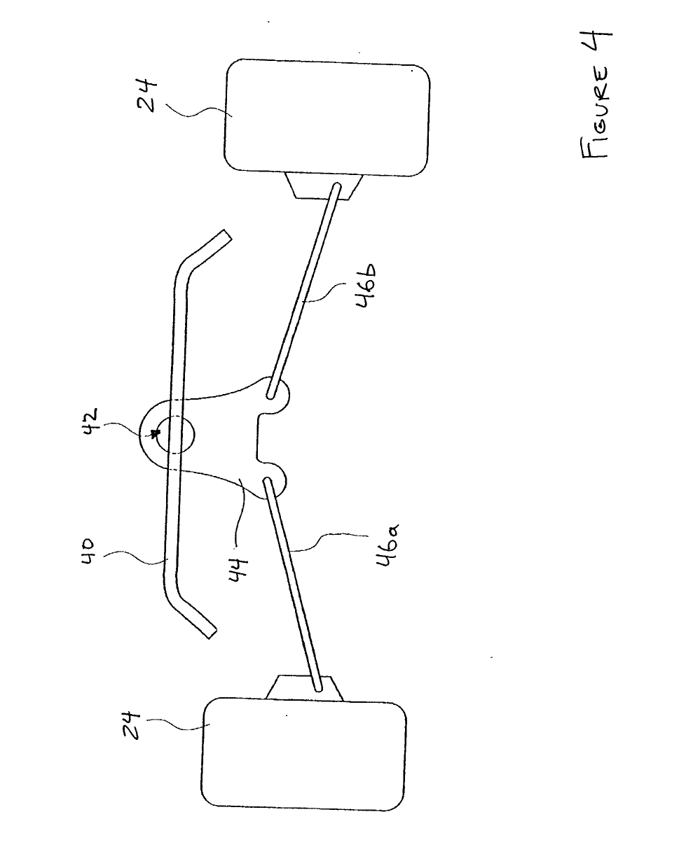

A handlebar assembly 40 is provided to allow an operator to steer the vehicle 20 and generally comprises a pair of grips 41 that are mounted at the outermost lateral ends of the handlebar assembly 40. The illustrated handlebar assembly 40 is connected to a front steering mechanism via a steering column 42. The steering column 42 and the handlebar assembly 40 operate to steer the front wheels 24 in any suitable manner. In the illustrated arrangement, the steering column, which can be supported by bearings, extends downward to a connecting plate, or a pitman arm 44 (FIG. 4). The connecting plate 44 can be connected to hubs of the front wheels 24 through left and right tie rods 46a, 46b, respectively.

Preferably, an internal combustion engine provides power to one set of wheels 24, 26 or both sets of wheels 24, 26. In the illustrated arrangement, the engine drives the rear wheels 26 through a suitable transmission. It should be recognized, that any engine operating principle can be used (e.g., two-cycle, four-cycle, rotary, etc.). In addition, any size or number of cylinders can be used.

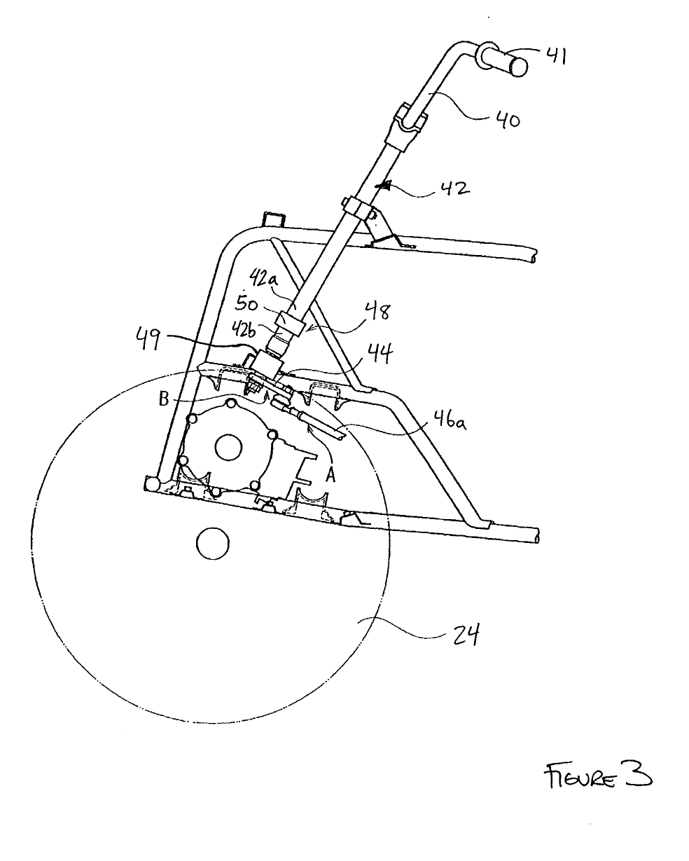

With reference to FIGS. 1-6, a first preferred torque detection device is described in greater detail. In the illustrated embodiment, a torque detection device 48 is incorporated into the steering column 42 to determine a steering torque that is applied to the steering column 42 through the handlebar assembly 40. Information regarding the detected torque is provided to a steering assist motor 49 (FIG. 3), which is configured to apply an assisting rotational force to the steering column 42 to assist in turning the front wheels 24. Preferably, the motor 49 includes an integral control system configured to receive an output signal from the torque detection device 48 and control an output of the motor 49 in accordance with a programmed control strategy. However, in other arrangements, the control system may be separate from the motor 49 and may control other components or systems of the vehicle 20 in addition to the motor 49. Furthermore, although the torque detection device 48 is illustrated in connection with a steering system of the vehicle 20, the device 48 may also be used to detect torque in other components of the vehicle, as will be appreciated by one of skill in the art.

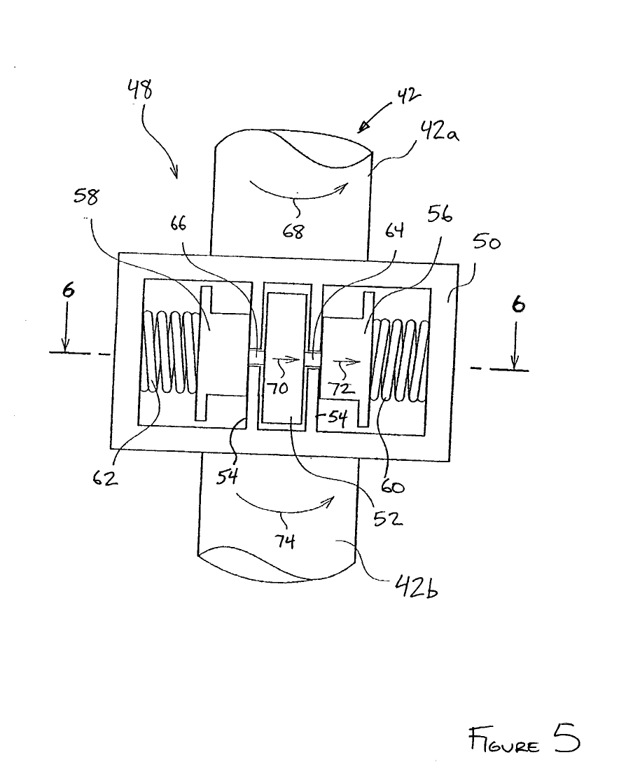

Preferably, the torque detection device 48 is positioned near a lower end of the steering column 42 and divides the steering column into an upper portion 42a and a lower portion 42b. With reference to FIG. 5, the torque detection device 48 includes a housing portion 50, which is coupled to the lower portion 42b of the steering column 42, and an input member 52, which is coupled, or integral with, the upper portion 42a of the steering column 42. Preferably, the housing 50 is a hollow, generally box-like member that extends forwardly of a portion of the steering column 42. The input portion 52 is a generally tab-like member, which extends axially outward from the steering column 42 and through an opening into an internal space defined by the housing portion 50. While identified as an input portion 52, the device 48 can be inverted with the input portion 52 serving as an output in some arrangements.

The housing 50 includes a pair of internal dividing walls 54, which are spaced from one another to divide the interior of the illustrated housing 50 into three internal spaces, or cavities. The input portion 52 resides between the pair of walls 54 and preferably is spaced at least slightly apart from the walls 54.

In the illustrated arrangement, a first sensor 56 is disposed within the left cavity of the housing (from the perspective of a rider seated on the vehicle 20 and facing a forward direction) and a second sensor 58 is disposed within the right cavity of the housing 50. The sensors 56, 58 preferably are magnetostrictive sensors. More preferably, the sensors 56, 58 have magnetic coils for detecting magnetic changes. Thus, the sensors 56, 58 define magnetostrictive sensors that use an inverse magnetostrictive effect when combined with the pressure receiving elements 64, 66.

A first spring 60 and a second spring 62 bias the first and second sensors 56, 58, respectively, into contact with a respective one of the interior walls 54. A first pressure receiving element 64 and a second pressure receiving element 66 are supported within a respective cavity of each of the interior walls 54. The first pressure receiving element 64 is in contact with both a first side of the input member 52 and the first sensor 56. Similarly, the second pressure receiving element 66 is in contact with both a second side of the input member 52 and the second sensor 58.

Preferably, the first and second pressure receiving elements 64, 66 are comprised of a material that exhibits a change in the value of a physical property as a result of deformation caused by a change in pressure applied thereto. In addition, preferably, the first and second sensors 56, 58 are configured to produce an output signal which has a predetermined relationship to the value of the relevant physical property of the first and second pressure receiving elements 64, 66. Thus, the first and second sensors 56, 58 produce an output signal that has a predetermined relationship with the pressure that is applied to the first and second pressure receiving elements 64, 66.

In a preferred embodiment, the pressure receiving elements 64, 66 comprise a material possessing advantageous magnetostrictive properties, such as iron, steel or nickel, for example, but without limitation. That is, preferably, the pressure receiving elements 64, 66 comprise a material that exhibits a consistent change in magnetic properties in an identifiable relationship to deformation resulting from a load that is applied thereto. In other arrangements, however, the pressure receiving elements 64, 66 may possess other physical properties (e.g., permeability) that change in an identifiable relationship to deformation. For example, the first and second pressure receiving elements 64, 66 may comprise an electrostatic capacitive electrode, a piezoelectric material, or an electric resistor. In each of these examples, the first and second sensors 56, 58 would be configured to produce an output signal corresponding with a value of the relevant property of the first and second pressure receiving elements 64, 66.

Preferably, the first and second springs 60, 62 are selected such that they apply an appropriate force to the first and second sensor 56, 58 to retain the first and second sensors 56, 58 in contact with the interior walls 54 of the housing 50 despite relative rotational movement between the input member 52 and the housing 50. That is, the springs 60, 62 are arranged such that they do not deflect upon normal steering motion of the steering column 42. Accordingly, the torque applied to the steering column 42 is transferred to the pressure receiving elements 64, 66. Preferably, the first and second springs 60, 62 only deflect if the torque generated within the steering column 42 is of a magnitude that would be sufficient to cause damage to the first or second sensors 64, 66. In other words, the springs allow the sensors to move away from the input portion 52 if the applied force would otherwise result in damage to the sensors or pressure receiving elements. Thus, the first and second springs 60, 62 are arranged to inhibit damage of the first and second sensors 64, 66 in the event of an extremely high torque being applied to the steering column 42, i.e., an overload protection function. In overload, the input portoin 52 directly contacts the walls 54.

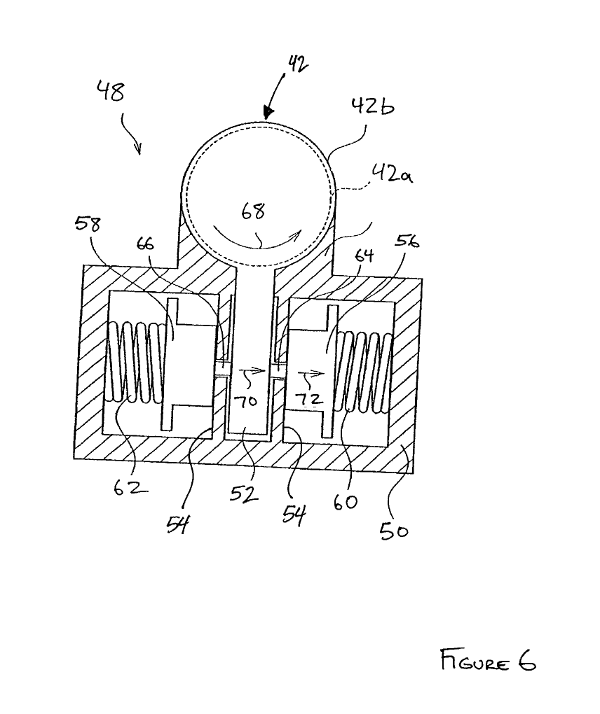

In operation, when an operator of the vehicle 20 turns the handlebar assembly 40 to the left, the upper portion 42a of the steering column 42 is rotated to the left, or counterclockwise, as illustrated by the arrow 68 in FIGS. 5 and 6. The input member 52 rotates with the upper portion 42a to apply a force to the first pressure receiving element 64 as indicated by the arrow 70. The pressure receiving section 64, in turn, applies a force to the first sensor 56, as indicated by the arrow 72, against the biasing force of the first spring 60. As described above, preferably, the first spring 60 does not compress in response to normal forces generated by steering of the handlebar assembly 40 under normal operational conditions. In some less desired applications, the springs can slightly compress.

Due to being compressed between the input member 52 and the first sensor 56, the pressure receiving element 64 is deformed (i.e., reduced in length) and exhibits a change in magnetic properties from that displayed in a relaxed position of the steering column 42. The first sensor 56 senses the change in magnetic properties of the first pressure receiving element 64 and generates an output signal corresponding to a torque of the steering column 42. A control system (not shown) may utilize the output signal of the first sensor 56 to operate a steering assist motor 49 to assist in rotation of the lower portion 42b of the steering column 42 as indicated by the arrow 74 in FIGS. 5 and 6.

Furthermore, the second pressure receiving section 66 also undergoes deformation (i.e., increases in length) as a result of movement of the upper portion 42a of the steering column 42 and the input member 52. The second sensor 58 may be configured to sense the change in magnetic properties of the second pressure receiving element 66 and create an output signal corresponding to the change. This output signal may also be utilized by the control system, in addition to the output signal of the first sensor 56, to determine the rotational torque of the upper portion 42a of the steering column 42. In such an arrangement, the control system utilizes the difference in the output signals produced by the first and second sensors 56, 58. As a result, any deformation of the first or second pressure receiving elements 64, 66 due to external factors, such as a change in ambient temperature for example, are cancelled out. Accordingly, the accuracy of the torque detection device is improved over prior torque detection arrangements.

Although not specifically shown, when an operator of the vehicle 20 turns the handlebar assembly 40 to the right (i.e., clockwise) the first and second pressure receiving elements 64, 66 and first and second sensors 56, 58 cooperate to provide output signals in a manner substantially identical to that described above. However, when turning right, the forces are applied in the opposite direction from that illustrated by the arrows in FIGS. 5 and 6.

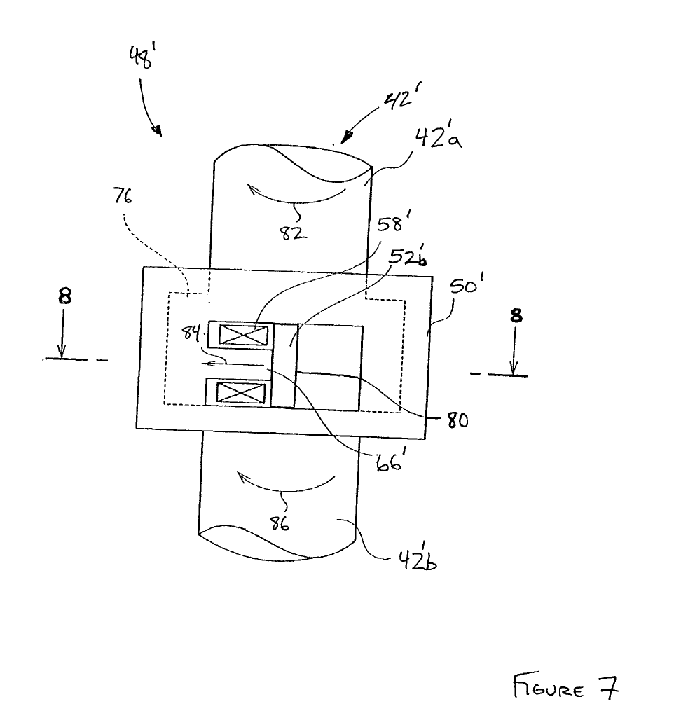

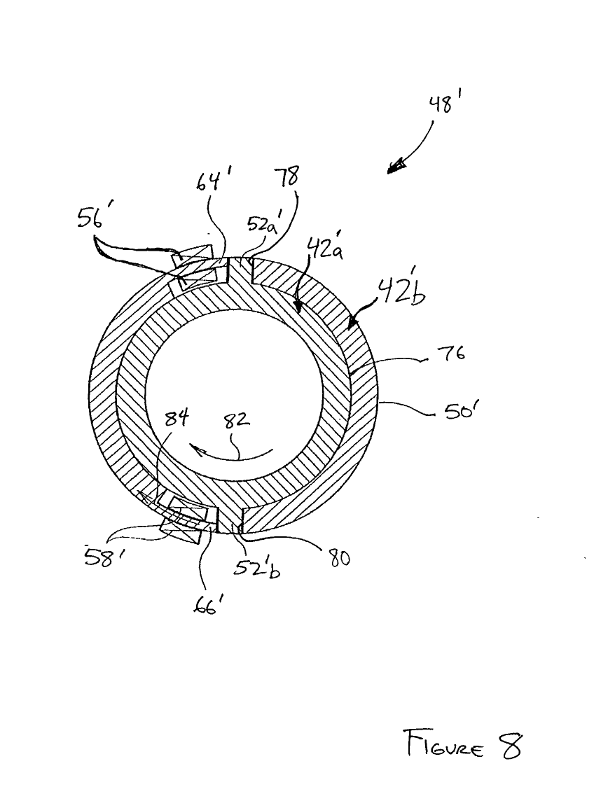

FIGS. 7 and 8 illustrate a modification of the torque detection device 48 of FIGS. 5 and 6, and generally is referred to by the reference numeral 48′. The torque detection device 48′ is substantially similar to the torque detection device 48 of FIGS. 5 and 6 and, therefore, like reference numerals are used to denote like components, except that a prime (′) is added.

The torque detection device 48′ of FIGS. 7 and 8 incorporates the first and second pressure receiving elements 64′, 66′ into the structure of the steering column 42′. As a result, the torque detection device 48′ may be manufactured with reduced dimensions in comparison to the device 48 described above, which permitted existing sensors to be used.

The upper portion 42a′ of the steering column 42′ includes an enlarged portion 76, having a generally cylindrical outer surface, at its lower end. The enlarged portion 76 occupies a cavity within the housing 50′. The housing 50′ includes a pair of openings 78, 80 within its front and rear walls, respectively. The upper portion 42a′ of the steering column 42′ includes a pair of input members 52a′, 52b′ extending axially outward from front and rear walls, respectively, of the upper portion 42a′ and through the openings 78, 80, respectively.

The first and second pressure receiving elements 64′, 66′ extend from a sidewall of the respective openings 78, 80 and abut the respective input members 52a′, 52b′. Thus, when the upper portion 42a′ of the steering column 42′ is rotated, the input members 52a′, 52b′ apply a force tending to reduce the length, or allow the pressure receiving elements 64′, 66′ to lengthen, depending on the direction of rotation. Furthermore, the pressure receiving elements 64′, 66′ may be integrated with the housing 50′ or, alternatively, may be separate members fastened to the housing 50′.

In the illustrated arrangement, the first and second sensors 56′, 58′ comprise magnetic coils wound around the first and second pressure receiving elements 64′, 66′. Thus, the coils are wrapped around respective cores that are position close to, but outside of, the pressure receiving elements. This construction generates a magnetic field that passes through the pressure receiving elements and, thus, changes in the magnetism of the pressure receiving elements can be detected.

As in the torque detection device of FIGS. 5 and 6, the sensors 56′, 58′ detect a value of a physical property of the first and second pressure receiving elements 64′, 66′ and, desirably, produce an output signal indicative of the torque applied to the steering column 42′.

In operation, when an operator of the vehicle 20 turns the handlebar assembly 40 to the right-hand side, i.e., in a clockwise direction, as indicated by the arrow 82, the second input member 52b′ applies a force to the second pressure receiving element 56′ as indicated by the arrow 84. As a result, the lower portion 42b′ of the steering column 42′ rotates along with the upper portion 42a′ as indicated by the arrow 86. The sensor 58′ produces an output signal indicating the torque applied to the steering column 42′. A control system may use this output signal to control an output of the power steering assist motor 49 to assist in turning of the steering column 42′. In addition, the force on the first pressure receiving element 64′ by the first input member 52a′ is reduced and thus, the first sensor 56′ produces an output signal indicating the reduced force on the pressure receiving element 64′. Accordingly, external factors, such as temperature changes, may be reduced by utilizing the difference in the output signals between the first sensor 56′ and the second sensor 58′ upon rotation of the steering column 42′ in either direction, as described above.

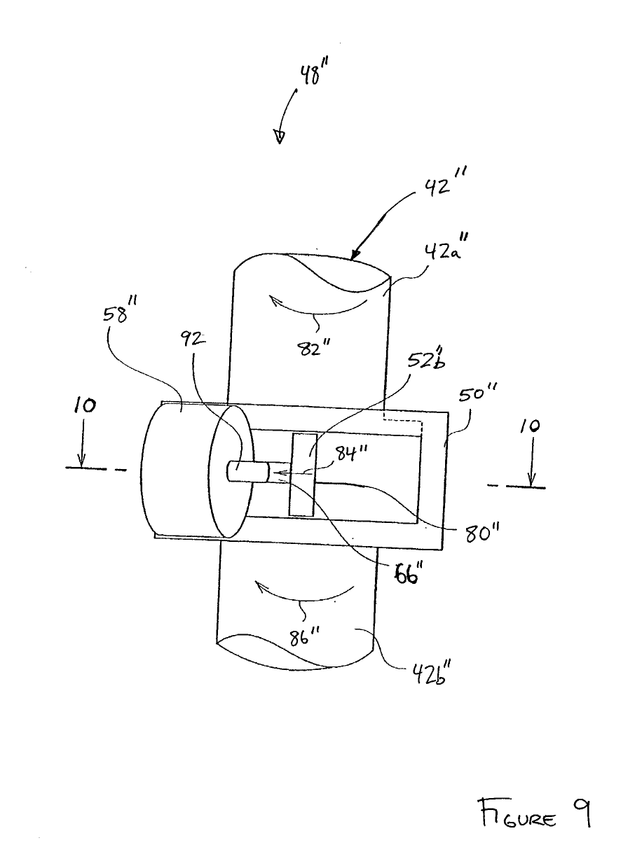

FIGS. 9 and 10 illustrate a modification of the torque detection device 48′ of FIGS. 7 and 8 and generally is referred to by the reference numeral 48″. The torque detection device 48″ is substantially similar to the torque detection devices 48 and 48′ and, therefore, like reference numerals are used to denote like components, except that a double prime (″) is added.

The housing 50″ includes a pair of openings 78″, 80″ which permit the first and second input members 52a″, 52b″ to pass therethrough in a manner similar to the housing 50′ of FIGS. 7 and 8. First and second pressure receiving elements 64″, 66″ extend from a wall of the respective opening 78″, 80″ and abut the respective input member 52a″, 52b″. However, the first and second sensors 56″, 58″ are not wrapped around the first and second pressure receiving elements 64″, 66″. Instead, a first core 90 and a second core 92 are provided in a slightly spaced orientation from the first and second pressure receiving elements 64″, 66″ and the first and second sensors 56″, 58″ are wound around the first and second core 90, 92.

Preferably, cores 90, 92 are made from a magnetic material that exhibits a change in a value of a magnetic property of the material in response to a change in the value of a magnetic property of the first and second pressure receiving elements 64″, 66″. Accordingly, the first and second sensors 56″, 58″ produce an output signal which corresponds with a value of a magnetic property of the first and second cores 90, 92 which, in turn, result due to a value of a magnetic property of the first and second pressure receiving elements 64″, 66″. As in the previous devices 48, 48′, the value of a magnetic property of the first and second pressure receiving elements 64″, 66″ is determined by the pressure applied by the first and second input members 52a″, 52b″. Thus, the construction of FIGS. 9 and 10 provide an inverse magnetostrictive sensor arrangement.

In the device 48″ of FIGS. 9 and 10, the cores 90, 92 and sensors 56″, 58″ are stationary (e.g., mounted to the frame 22) with respect to the steering column 42″. As a result, any necessary wiring from the sensors 56″, 58″ to the control system of the motor 49, or other control system, may be simplified. As apparent from FIG. 10, the pressure receiving elements 64″, 66″ each occupy a sufficient portion of the circumference of the steering column 42″ to permit the sensors 56″, 58″ to detect a load applied to the pressure receiving elements 64″, 66″ throughout a significant portion, if not all, of the range of motion of the steering column 42″. In the illustrated embodiment, the steering torque may be detected for approximately 50 degrees in each direction from a neutral (i.e., straight) steering position. Such an arrangement has particular utility with vehicles having a smaller lock-to-lock angle for the steering column, such as all terrain vehicles, for instance. In other respects, the torque detection device 48″ operates in a substantially identical manner to the torque detection device 48′ of FIGS. 7 and 8. Accordingly, further description is not deemed necessary in order to practice the invention.

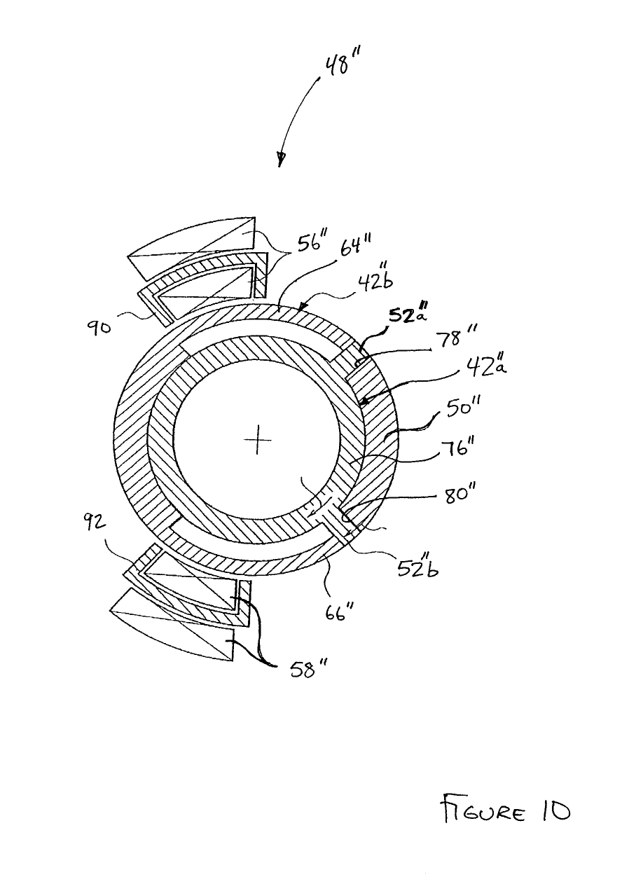

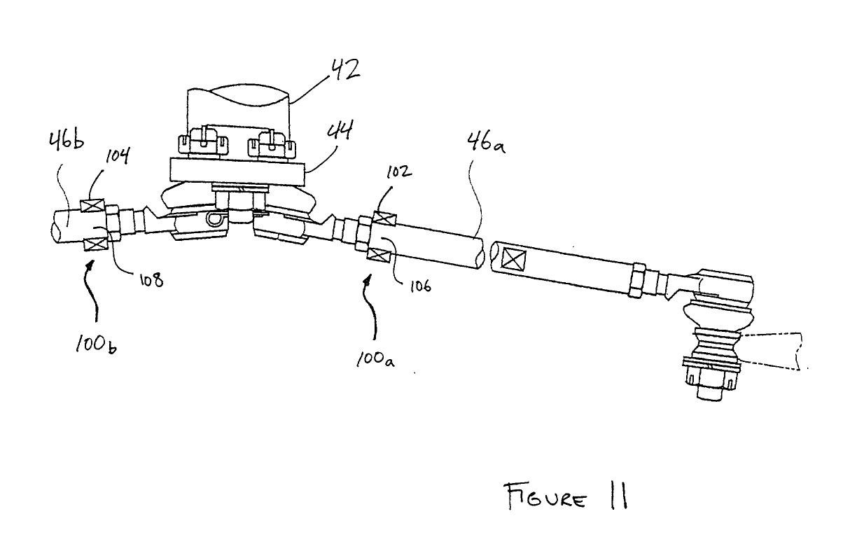

With reference to FIGS. 11 and 12, an alternative construction of a torque detection device 100 is described. The torque detection device 100 operates on generally the same principles as the torque detection devices 48, 48′, 48″, but is not incorporated within the steering column 42 of the vehicle 20. Accordingly, the device 100 may be easily retrofitted to existing vehicles. In the torque detection device of FIGS. 11 and 12, a pair of detection devices 100 are provided on each tie rod 46a, 46b near an upper end of the tie rods 46a, 46b, as generally indicated by the reference character A of FIGS. 2 and 3. However, the devices 100 may be provided at any suitable location along the length of the tie rods 46a, 46b.

Preferably, a torque detection device 100 is provided on each tie rod 46a, 46b so that the control system (not shown) may utilize a difference in the output signals between the detection devices 100 on each tie rod 46a, 46b to generate a control signal for the power steering assist motor 49. Accordingly, with such an arrangement, variations in the output signals of the devices 100 due to external factors, such as changes in temperature, may be cancelled out.

Thus, a first sensor 102 is disposed around the first tie rod 46a and a second sensor 104 is disposed around a portion of the second tie rod 46b. As illustrated in FIG. 12, at least a portion of the tie rod 46a that is surrounded by the first sensor 102 is comprised of a material that alters in magnetic properties as a result of deformation due to a pressure exerted thereon. Thus, at least the portion of the tie rod 46a surrounded by the first sensor 102 comprises a first pressure receiving element 106. The pressure receiving element 106 may be integral with, or coupled to, the tie rod 46a. Although not specifically shown, preferably the torque detection device 100 of the right tie rod 46b is constructed substantially identically to the device 100 of FIG. 12.

With such an arrangement, when an operator of the vehicle 20 turns the handle bar assembly 40, a compression force is applied to one of the tie rods 46a, 46b while a tensile force is applied to the other of the tie rods 46a, 46b. Thus, the torque detection device 100 of each tie rod 46a, 46b produces an output signal corresponding to a magnitude of the force applied to, or the deformation of, each tie rod 46a, 46b. These output signals may be utilized by a control system to control a power steering assist motor 49 substantially in the manner described above to assist in steering of the vehicle 20. In some arrangements, adjustments to the lengths of the tie rods 46a, 46b can be used to tune the output signals.

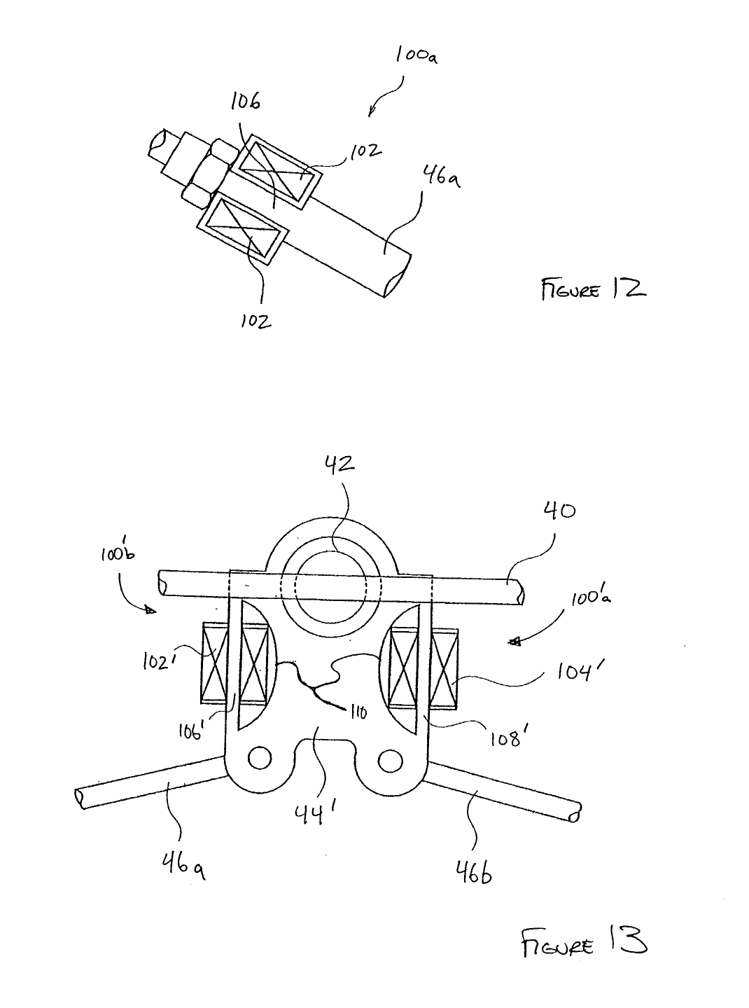

FIG. 13 illustrates a modification of the torque detection device 100 of FIGS. 11 and 12 and is indicated generally by the reference numeral 100′. The torque detection device 100′ is substantially similar to the torque detection device 100 and, thus, like reference numerals are used to denote like components, except that a prime (′) is added.

The torque detection devices 100a′, 100b′ of FIG. 13 are incorporated within the connecting plate 44′, or pitman arm, of the steering assembly of the vehicle 20 as indicated generally by the reference character B in FIGS. 2 and 3. The illustrated connecting plate 44′ includes a pair of generally semicircular openings 110 near the opposing lateral edges of the connecting plate 44′. While the semicircular shape is desired for strength, other shapes also can be used for the openings. The linear side of each opening 110 is positioned adjacent a respective lateral edge of the connecting plate 44′ such that a portion of the connecting plate 44′ spanning the openings 110 define first and second pressure receiving elements 106′, 108′. The openings 110 permit first and second sensors 102′, 104′ to be positioned around the first and second pressure receiving elements 106′, 108′.

Accordingly, when an operator of the vehicle 20 rotates the handlebar assembly 40 in either direction, a compressive force is applied to one of the first and second pressure receiving elements 106′, 108′ and a tensile force is applied to the other of the first and second pressure receiving elements 106′, 108′. As in the device 100 of FIGS. 11 and 12, the sensors 102′, 104′ produce an output signal corresponding to the pressure applied to, or deformation of, the first and second pressure receiving elements 106′, 108′. The output signals are utilized by a control system (not shown) to control an output of a power steering assist motor 49, which assists in turning of the steering column 42. As in the torque detection device 100 of FIGS. 11 and 12, preferably the control system utilizes the difference in output between the first and second torque detection device 100a′, 100b′ in order to negate any variation in the output signal due to external factors, such as changes in ambient temperature.

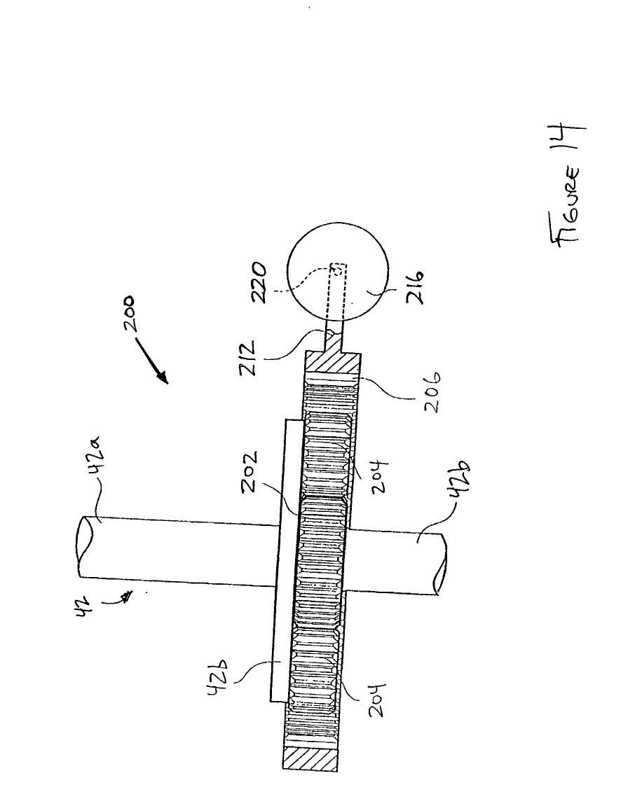

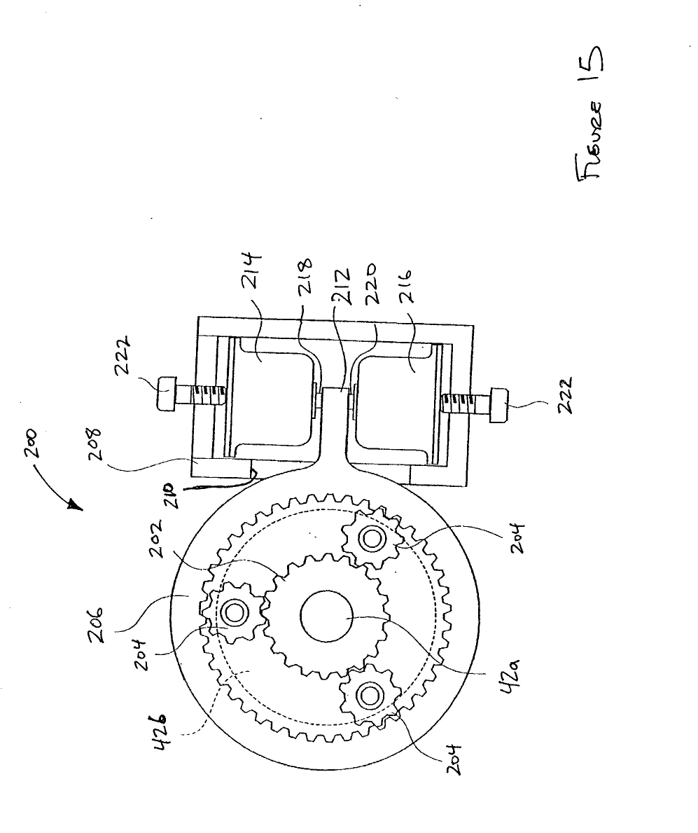

FIGS. 14 and 15 illustrate an alternative construction of a torque detection device, indicated generally by the reference numeral 200. The torque detection device 200 is incorporated into a steering column 42 of a vehicle, such as vehicle 20 of FIGS. 1-4. The torque detection device 200 divides the steering column 42 into an upper portion 42a and a lower portion 42b. The upper portion 42a includes a sun gear 202 at, or near, its lower end. An enlarged, upper end of the lower portion 42b supports a plurality of planet gears, or pinions 204. The planet gears 204 are intermeshed with the sun gear 42a and are rotatable relative to the lower portion 42b of the steering column 42. In the illustrated arrangement, three planet gears 204 are provided. However, a lesser or greater number of planet gears may be incorporated in the torque detection device 200, as may be determined by one of skill in the art. A ring gear 206 surrounds the steering column 42 and is engaged by the planet gears 204.

A housing 208, similar to the housing 50 of FIGS. 5 and 6, is attached to a portion of the vehicle 20 adjacent the steering column 42 and includes an opening 210. The ring gear 206 includes an input member 212 extending in a radially outward direction from the steering column 42, similar to the input member 52 of FIGS. 5 and 6. The input member 212 passes through the opening 210 and into an interior space of the housing 208.

A first sensor 214 and a second sensor 216 are positioned within the housing on opposing sides of the input member 212. A first pressure receiving element 218 and a second pressure receiving element 220 are interposed between the first sensor 214 and the input member 212 and the second sensor 216 and the input member 212, respectively. A pair of bolts 222 are threaded into opposing ends of the housing 208 to press the first and second sensors 214, 216 and the first and second pressure receiving elements 218, 220 into contact with the input member 212. In addition, the bolts may be used to adjust an output signal of the sensors 214, 216 when the input member 212 and thus, the handlebar assembly 40, is in a neutral (i.e., straight) position.

When an operator of the vehicle 20 rotates the handlebar assembly 40, the upper portion 42a of the steering column 42 is also rotated. As a result, the sun gear 202 is rotated which, in turn, rotates the planet gears 204. The ring gear 206 is substantially fixed, due to the input member 212 being held between the first and second sensors 214, 216 and the first and second pressure receiving elements 218, 220 within the housing 208, which is fixed to the vehicle 20, as described above. As a result, rotation of the planet gears 204 causes rotation of the lower portion 42b of the steering column 42 along with rotation of the upper portion 42a due to the intermeshing of the sun gear 202 and planet gears 204.

A reaction force is applied to the ring gear 206, which is transmitted to the first and second pressure receiving elements 218, 220. The deflection of the first and second pressure receiving elements 218, 220 is sensed by the first and second sensors 214, 216 as in the arrangements described above. The first and second sensors 214, 216 produce an output signal corresponding to a rotational torque applied to the upper portion 42a of the steering column 42. As described above, a control assembly may be provided to utilize the outputs of the first and second sensors 214, 216 to control an output of the power steering assist motor 49, which assists in rotating the steering column 42 and, in turn, turn the front wheels 24 of the vehicle 20.

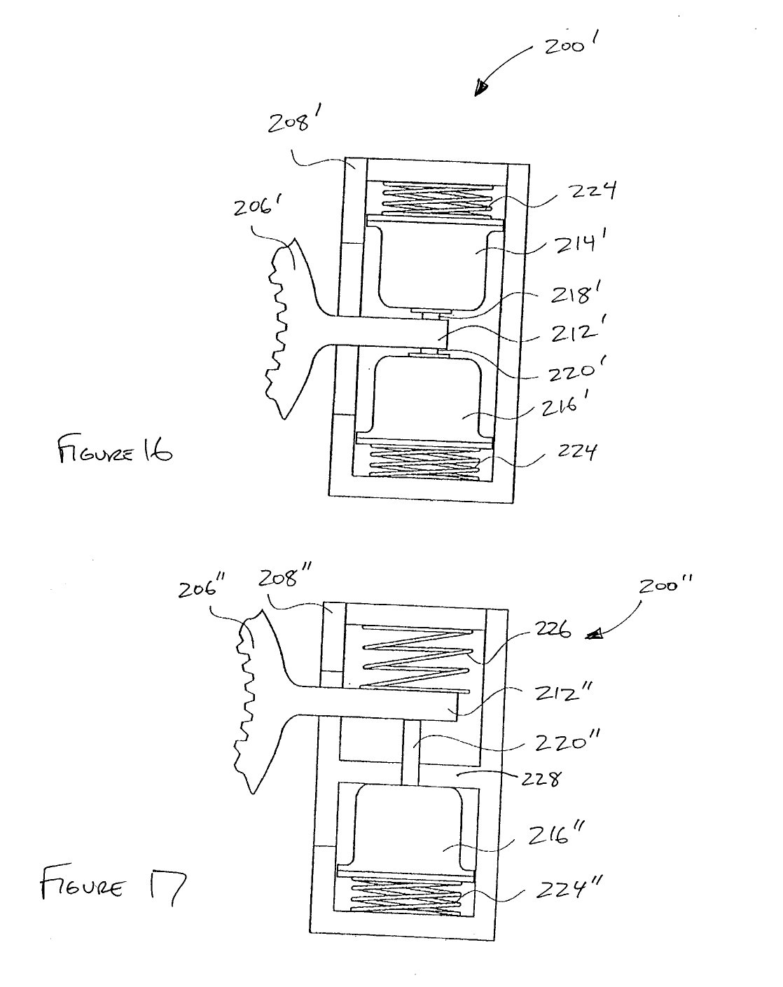

FIG. 16 illustrates a modification of the torque detection device 200 of FIGS. 14 and 15 and generally is referred to by the reference character 200′. The torque detection device 200′ is substantially similar to the torque detection device 200 and, therefore, like reference numerals are used to denote like components, except that a prime (′) is added.

In the device 200′ of FIG. 16, a pair of springs 224 are interposed between the housing 208 and the first and second sensors 214, 216 in a manner similar to the torque detection device 48 of FIGS. 5 and 6. Thus, the torque detection device 200′ incorporates an overload protection arrangement, due to the springs 224, to inhibit damage the torque detection device 200′ when an abnormally high rotational torque is applied to the steering column 42.

FIG. 17 illustrates a modification of the torque detection device 200′ of FIG. 16 and generally is referred to by the reference numeral 200″. The torque detection device 200″ of FIG. 17 is substantially similar to the torque detection device 200′ and, therefore, like reference numerals are used to denote like components, except that a double prime (″) is added.

The torque detection device 200″ incorporates only a single sensor 216″ and a single pressure receiving element 220″. A spring 226 is provided between the input member 212″ and the end of the housing 208″ opposing the first sensor 216″. In addition, the housing 208″ may include an internal wall 228 having a cavity to assist in supporting the pressure receiving element 220″. The internal wall 228 also retains the sensor 216″ in a desired position, due to the differences in the forces applied by the springs 224″, 226, as described below.

The spring 226 is arranged to apply approximately one-half of the force to the input member 212″ in comparison with the force applied by the spring 224″. Accordingly, in a neutral position of the steering column 42 (and input member 212″), a compression force equivalent to the one-half the force of the spring 224″ is applied to the pressure receiving element 220″. When the input member 212″ exerts a force due to rotation of the upper portion 42a of the steering column 42, the load is either added or subtracted from the load applied by the spring 226, depending on the rotational direction of the steering column 42. As a result, an overload prevention function is provided, as in the device 200′ of FIG. 16. However, only one-half the number of sensors and pressure receiving elements are necessary, thereby reducing the overall cost of the torque detection device 200″.

As will be apparent to one of skill in the art as a result of the foregoing discussion, the preferred torque detection devices provide an accurate and reliable indication of the torque applied to a steering column of a vehicle. The preferred embodiments are not influenced by axial loads on the steering column, such as those due to absorbing bumps or weight transfer of an operator of the vehicle. Furthermore, the accuracy of the device is not dependent on machining accuracy of the an outer diameter of the steering column. If a difference calculation is used between the first and second sensors, the accuracy of the device is not influence by external conditions, such as changes in ambient temperature. Finally, the devices may be incorporated on a variety of vehicles using a steering column in addition to ATVs, such as personal watercraft for example. As a result, the preferred torque detection devices described herein represent a significant improvement over previously known devices.

Although the present invention has been described in terms of certain preferred embodiments, other embodiments apparent to those of ordinary skill in the art also are within the scope of this invention. Thus, various changes and modifications may be made without departing from the spirit and scope of the invention. Moreover, not all of the features, aspects and advantages are necessarily required to practice the present invention. Accordingly, the scope of the present invention is intended to be defined only by the claims that follow.

What is claimed is:

1. An all-terrain vehicle comprising a frame assembly, at least one front wheel, at least one rear wheel, a handlebar assembly coupled to the at least one front wheel by a steering assembly, the steering assembly comprising a steering column, a torque detection device configured to detect a torque applied to the steering column, the torque detection device comprising at least one pressure receiving element and at least one sensor, the steering assembly being configured to apply a load to the at least one pressure receiving element during rotation of the steering column, the at least one sensor being configured to detect a change in a property of the at least one pressure receiving element caused by the load applied to the at least one pressure receiving element.

2. The all-terrain vehicle of claim 1, additionally comprising a control system, the at least one sensor being configured to produce an output signal corresponding with the load applied to the at least one pressure receiving element, the control system being configured to determine the torque applied to the steering column using the output signal.

3. The all-terrain vehicle of claim 2, additionally comprising a steering assist motor configured to assist rotation of the steering column, wherein the control system is configured to control an output of the steering assist motor in accordance with a predetermined relationship to the torque applied to the steering column.

4. The all-terrain vehicle of claim 1, wherein the at least one pressure receiving element comprises a first pressure receiving element and a second pressure receiving element and the at least one sensor comprises a first sensor configured to detect the load applied to the first pressure receiving element and a second sensor configured to detect the load applied to the second pressure receiving element, the steering assembly being configured to apply a compressive load to the first pressure receiving element when the steering column is rotated in a first direction and apply a compressive load to the second pressure receiving element when the steering column is rotated in a second direction.

5. The all-terrain vehicle of claim 4, additionally comprising a control system, the first sensor being configured to produce a first output signal corresponding with the load applied to the first pressure receiving element and the second sensor being configured to produce a second output signal corresponding with the load applied to the second pressure receiving element, the control system being configured to determine the torque applied to the steering column using the difference between the first output signal and the second output signal.

6. The all-terrain vehicle of claim 1, wherein the steering column comprises a first portion and a second portion, the first portion having an input member configured to apply a load to the at least one pressure receiving element upon rotation of the first portion steering column, the at least one pressure receiving element applying a torque to the second portion of the steering column to cause rotation of the second portion along with the first portion.

7. The all-terrain vehicle of claim 6, wherein the at least one sensor is fixed for rotation with the second portion of the steering column.

8. The all-terrain vehicle of claim 1, wherein the torque detection device comprises a planetary gear arrangement comprising a sun gear, a ring gear and a plurality of planet gears, the steering column having a first portion and a second portion, the sun gear being fixed for rotation with the first portion and the plurality of planet gears being fixed for rotation with the second portion, the sun gear engaging the planet gears, the ring gear engaging the planet gears and comprising an input member configured to apply the load to the at least one pressure receiving element during rotation of the steering column.

9. The all-terrain vehicle of claim 1, wherein the at least one pressure receiving element comprises a magnetic material exhibiting a change in magnetic properties corresponding to a change in load on the material, the at least one sensor being configured to detect a value of the magnetic properties of the at least one pressure receiving element.

10. The all-terrain vehicle of claim 9, wherein the at least one sensor comprises a magnetic coil wound around the at least one pressure receiving element.

11. The all-terrain vehicle of claim 9, wherein the at least one sensor comprises a magnetic coil wound around a magnetic transducer element, the transducer element being positioned proximate and in a non-contact arrangement with the at least one pressure receiving element and exhibiting a change in magnetic properties corresponding with the change in magnetic properties of the at least one pressure receiving element.

12. The all-terrain vehicle of claim 1, wherein the at least one pressure receiving element comprises an electrostatic capacitive electrode exhibiting a change in capacitance properties corresponding to a change in load on the material, the at least one sensor being configured to detect a value of the capacitance properties of the at least one pressure receiving element.

13. The all-terrain vehicle of claim 1, wherein the at least one pressure receiving element comprises a piezoelectric element exhibiting a change in electrical properties corresponding to a change in load on the material, the at least one sensor being configured to detect a value of the electrical properties of the at least one pressure receiving element.

14. The all-terrain vehicle of claim 1, wherein the at least one pressure receiving element comprises a resistor element exhibiting a change in electrical resistance properties corresponding to a change in load on the material, the at least one sensor being configured to detect a value of the electrical resistance properties of the at least one pressure receiving element.

15. An all-terrain vehicle comprising a frame assembly, a pair of front wheels, at least one rear wheel, a handlebar assembly coupled to the at least one front wheel by a steering assembly, the steering assembly comprising a steering column, a connector plate and a pair of tie rods, the connector plate being fixed for rotation with the steering column, each of the pair of tie rods extending from the connector plate to one of the pair of front wheels, a torque detection device configured to detect a torque applied to the steering column, the torque detection device comprising a first pressure receiving element, a second pressure receiving element, a first sensor configured to detect the load applied to the first pressure receiving element and a second sensor configured to detect the load applied to the second pressure receiving element, the steering assembly being configured to apply a compressive load to the first pressure receiving element during rotation of the steering column in a first direction and apply a compressive load to the second pressure receiving element during rotation of the steering column in a second direction.

16. The all-terrain vehicle of claim 15, wherein the first and second pressure receiving elements are located on the connecting plate.

17. The all-terrain vehicle of claim 15, wherein the first pressure receiving element is located on the one of the pair of tie rods and the second pressure receiving element is located on the other of the pair of tie rods.

18. The all-terrain vehicle of claim 17, wherein the first and second pressure receiving elements form a portion of the pair of tie rods.

19. A method for detecting a torque applied to a steering column of a vehicle comprising providing at least one pressure receiving element exhibiting a change in a physical property resulting from a change in a load applied, applying a load to the at least one pressure receiving element during rotation of the steering column, determining a value of the physical property of the at least one pressure receiving element as a result of the load applied, and calculating the torque applied to the steering column using the detected value of the physical property.

20. The method of claim 19, wherein the at least one pressure receiving element comprises a first pressure receiving element and a second pressure receiving element, the method additionally comprising comparing the value of the physical property of the first pressure receiving element and the value of the physical property of the second pressure receiving element, and calculating the torque applied to the steering column using the difference between the detected values of the first and second pressure receiving elements.

21. The method of claim 19, wherein the detected physical property is a magnetic property of the pressure receiving element, and calculating the torque applied to the steering column using the detected value of the magnetic property.
